(19) United States
(12) Patent Application Publication
(10) Pub. No.: US 2009/0130468 A1
(43) Pub. Date: May 21, 2009

(54) POLYAMIC ACID COMPOSITION, METHOD FOR PREPARING THE SAME, METHOD FOR PREPARING POLYIMIDE AND POLYIMIDE FLEXIBLE METAL-CLAD LAMINATES

(76) Inventor: Li-Hua WANG, Taipei (TW)

Correspondence Address: RABIN & Berdo, PC, 1101 14TH STREET, NW, SUITE 500, WASHINGTON, DC, 20005, US

(21) Appl. No.: 11/941,176

(22) Filed: Nov. 16, 2007

(51) Int. Cl. C08G 73/00; B32B 15/08

(52) U.S. Cl. 428/458; 528/422

(57) ABSTRACT

The present invention provides a polyamic acid composition obtained by addition polymerization of an aromatic diamine and an aromatic dianhydride in a solvent, and then the imidazole or derivatives thereof (or triazole or derivatives thereof), and epoxy resin are added thereto. When the polyamic acid composition, which contains imidazole or derivatives thereof (or triazole or derivatives thereof), and epoxy resin, is cast onto a clean metal foil and then heated and imidized to form a polyimide insulating layer, the imidazole or derivatives (or triazole or derivatives thereof) will react with the epoxy resin to form a polymer during imidation.

### BACKGROUND OF THE INVENTION

1. Field of the Invention

The present invention relates to a polyamic acid composition, a method for preparing the same, a method for preparing polyimide from the polyamic acid composition, and a flexible metal-clad laminate, wherein the polyamic acid composition does not give vapor residue substance during imidizing reaction, and also a strong adhesive strength between the polyimide insulating layer and the metal foil in the flexible metal-clad laminate can be achieved.

2. The Prior Arts

Among various types of printed circuit boards of the portable electronic devices (such as cell phones, personal digital assistants), the flexible printed circuit boards are widely used because they can greatly reduce the volume, the weight, and the manufacturing cost of the portable electronic devices.

The polyamic acid composition can be directly cast onto a metal foil and imidized by heating to form the polyimide insulating layer, and thus the flexible metal-clad laminates is produced. For example, the polyamic acid varnish is obtained through the addition polymerization of an aromatic diamine (such as a paraphenylenediamine) and an aromatic dianhydride (such as pyromellitic dianhydride) in the presence of a solvent (such as dimethylacetamide or N-methyl-2-pyrrolidone). Subsequently, the polyamic acid varnish is applied onto a metal foil, and the whole is dried, and then heated and imidized in an oven at 300 to 400° C. to form one or more polyimide insulating layers on the metal foil, and thus a flexible metal-clad laminate is manufactured.

However, when the polyamic acid varnish is applied to the metal foil, the presence of carboxyl groups in the polyamic acid gives rise to such problems as the corrosion of the metal foil surface which will reduce adhesive strength between the polyimide and the metal foil, as well as the formation of metal ions which bring about electrical migration in the flexible metal-clad laminates.

Japanese patent laid-open publication No. H04-85363 taught that imidazole, derivatives thereof or salts thereof; or triazole, derivatives thereof or salts thereof were added to the polyamic acid varnish as rust inhibitors. In addition, Japanese patent laid-open publication No. 2001-172564 taught that imidazolyl-diaminotriazines were added to the polyamic acid varnish as rust inhibitors. However, although the conventional rust inhibitors can solve the problem of the reduction of adhesive strength between the polyimide insulating layer and the metal foil, part of these rust inhibitors will be vaporized at high temperature during the step of imidation, resulting in contamination of a flexible printed board, and deterioration of an electronic circuit (e.g. the conduction becomes impaired) subsequently formed. Moreover, the vapor residue substance of the rust-inhibitors can contaminate the process apparatus, and also can exist in the form of dust that will contaminate the clean environment such as the clean rooms.

Moreover, Japanese patent laid-open publication No. 2000-210080 taught that a polyimide was obtained by imidizing a polyamic acid obtained by the addition reaction of specific imidazolyl-diaminotriazines as a diamine component of polyamic acid to an dianhydride, and thus an imidazole ring was introduced into the side chain of the polyamic acid. However, in order to achieve the rust inhibiting effect, it is necessary to copolymerize more than one kind of the imidazolyl-diaminotriazines, and in such a way, the obtained polyimide was liable to be easily decolored upon heating.

### SUMMARY OF THE INVENTION

Accordingly, the objective of the present invention is to provide a polyamic acid composition and a method for preparing the same so that the flexible metal-clad laminate, which comprises a polyimide insulating layer formed from the polyamic acid composition, has excellent rust-inhibiting effect, and also the formation of vapor residue substance other than water will not occur during the step of imidation, and thereby the surface of the metal foil will not be contaminated. Therefore, a adhesive strength between the polyimide insulating layer and the copper foil in the flexible metal-clad laminate becomes strong. Moreover, the problems of the contamination of the imidation process apparatus and the contamination of the clean environment by the vapor residue substance from the vaporization of the rust-inhibitor can be avoided.

To achieve the foregoing objective, the present invention provides a polyamic acid composition obtained by addition polymerization of an aromatic diamine and an aromatic dianhydride in a solvent, and then the imidazole or derivatives thereof (or triazole or derivatives thereof), and epoxy resin are added thereto. When the polyamic acid composition, which contains imidazole or derivatives thereof (or triazole or derivatives thereof) and epoxy resin, is cast onto a clean metal foil and then heated and imidized to form a polyimide insulating layer, and the imidazole or derivatives thereof, or the triazole or derivatives thereof will react with the epoxy resin to form a polymer during imidation. Thus, a flexible metal-clad laminate, which comprises a polyimide insulating layer formed by imidizing the polyamic acid composition cast on a metal foil, has excellent rust-inhibiting effect, and also the formation of the vapor residue substance of the rust-inhibitors will not occur.

According to the present invention, an adhesive strength between the polyimide insulating layer and the copper foil of the flexible metal-clad laminate is strong and stable. Also, the formation of vapor residue substance will not occur during the step of imidation so that the imidation process apparatus and the surface of the metal foil of flexible metal-clad laminate will not be contaminated. Moreover, the formation of vapor residue substance of the rust-inhibitors existing in the form of dust does not occur so that the clean environment can be maintained.

### DETAILED DESCRIPTION OF THE PREFERRED EMBODIMENT

The present invent provides a method for preparing a polyamic acid composition, comprising: adding at least one imidazole or derivatives thereof (or at least one triazole or derivatives thereof) and at least one epoxy resin into a solution which contains a polyamic acid obtained by addition polymerization of at least one aromatic diamine and at least one aromatic dianhydride in the presence of a solvent. The polyamic acid composition containing at least one imidazole or derivatives thereof (or at least one triazole or derivatives thereof) and at least one epoxy resin is then cast onto a metal foil and imidized to form one or more polyimide insulating layers on the metal foil, and during the step of imidation the at least one epoxy resin is reacted with the at least one imidazole or derivatives thereof, or the at least one triazole or derivatives thereof to form a polymer, and that is the reason why the rust-inhibitors (i.e. the imidazole or derivatives and the triazole or derivatives) can be prevented from being volatilized.

The epoxy resin does not adversely affect the rust-inhibiting effect of the imidazole or derivatives thereof, or the triazole or derivatives thereof while the existence of it can prevent these rust-inhibitors from being vaporized.

According to the present invention, at least one imidazole or derivatives thereof (or at least one triazole or derivatives thereof), and at least one epoxy resin are added into a varnish which contains a polyamic acid obtained by addition polymerization of at least one aromatic diamine and at least one aromatic dianhydride in the presence of a solvent.

According to the present invention, the epoxy resin can be directly added to the polyamic acid composition containing at least one imidazole or derivatives thereof, or at least one triazole or derivatives thereof. Alternatively, the epoxy resin is dissolved in a solvent, and then added into the polyamic acid composition containing at least one imidazole or derivatives thereof, or at least one triazole or derivatives thereof. Subsequently, the polyamic acid composition is cast onto a clean metal foil to a desired thickness, and then dried, heated and imidized to form a polyimide insulating layer on the metal foil, and thus the flexible metal-clad laminate of the present invention is produced.

According to the present invention, the imidazole or derivatives thereof and the triazole or derivatives thereof, which have the rust-inhibiting effect, can be used with the commercially available epoxy resin as a hardener (accelerator). Specific examples of imidazole or derivatives thereof useful in the present invention include 2-methylimidazole, 2-undecylimidazole, 2-ethyl-4-methylimidazole, 2,4-diamino-6-[2′-methylimidazoyl-(1′)]-ethyl-s-triazine), 2,4-diamino-6-[2′-undecylimidazoyl-(1′)]-ethyl-s-triazine), and 2,4-diamino-6-[2′-ethyl-4′-methylimidazoyl-(1′)]-ethyl-s-triazine. Specific examples of triazole or derivatives thereof. useful in the present invention include 3-(N-salicyloyl)amino-1,2,3-triazin. However, any imidazoles and triazoles can be used in the present invention as long as the melting points of these rust-inhibitors are high enough.

According to the present invention, the imidazole or derivatives thereof, or the triazole or derivatives thereof can be used in an amount of from 1% to 10% by weight, and preferably from 3% to 7% by weight, based on the weight of the polyamic acid. If the rust-inhibitors are used in an amount of less than 1% by weight based on the weight of the polyamic acid, the rust-inhibiting effect will be insufficient. If the rust-inhibitors are used in an amount of more than 10% by weight based on the weight of the polyamic acid, the rust-inhibitors (i.e. the imidazole or derivatives and the triazole or derivatives) cannot be prevented from being vaporized even in the presence of the epoxy resin.

The epoxy resin used in the present invention is able to be dissolved in an organic solvent, and has two or more epoxy groups per molecule. On the other hand, if the rust-inhibitors (i.e. the imidazole or derivatives, or the triazole or derivatives) can be miscible with the polyamic acid, the transparency of the obtained polyimide insulating layer from the imidation of the polyamic acid composition will become high. Specific examples of the epoxy resin useful in the present invention include cresol-novolak type epoxy resin, epoxy resin containing four functional naphthalene skeleton, naphthol-novolak type epoxy resin, naphthol-alkyl type epoxy resin, bisphenol A type epoxy resin, phenol-novolak type epoxy resin, glycidyl-amino type epoxy resin.

According to the present invention, the epoxy resin can be used in an amount of from 1% to 20% by weight, and preferably from 3% to 10% by weight, based on the weight of the polyamic acid. If the epoxy resin is used in an amount of less than 1% by weight based on the weight of the polyamic acid, the rust-inhibitors (i.e. the imidazole or derivatives and the triazole or derivatives) cannot be prevented from being vaporized. If the epoxy resin is used in an amount of more than 20% by weight based on the weight of the polyamic acid, the miscibility of the epoxy resin with the polyamic acid will become poor.

The polyamic acid is obtained by the addition polymerization of an aromatic diamine and an aromatic dianhydride in a solvent. In order to maintain the flatness of the surface of the flexible metal-clad laminate, the thermal expansion coefficient of the polyimide insulating layer should match that of the metal (e.g. copper) foil. Consequently, it is necessary that the addition proportion of the aromatic diamine and the addition proportion of the aromatic dianhydride are adjusted so that the thermal expansion coefficient of the polyimide insulating layer manufactured from them can match that of the metal (e.g. copper) foil. Specific examples of the aromatic dianhydride useful in the present invention include pyromellitic dianhydride, 3,3′,4,4′-biphenyl tetracarboxylic dianhydride, bis(3,4-dicarboxyphenyl)sulfone dianhydride, bis(3,4-dicarboxyphenyl)ether dianhydride, and 3,3′,4,4′-benzophenone tetracarboxylic dianhydride. Specific examples of the aromatic diamine useful in the present invention include para-phenylene diamine, 4,4′-diaminophenyl ether, 2,2-bis(4-[4-aminophenoxy]phenyl)propane, 2,2-bis(4-[4-aminophenoxy]phenyl)sulfone, 4,4′-diaminobenzanilide, and 1,4-bis(4-aminophenoxy)benzene.

The type of the solvent to be used in the present invention is not specifically limited, as long as the solvent to be used is inactive to the polymerization reaction and can dissolve the monomers, the additives, and the polymer products involved in the polymerization reaction. Specific examples of the solvent useful in the present invention include pyrrolidinones (such as N-methylpyrrolidinone), acetamides (such as dimethylacetamide), phenols (such as cresol). However, in view of safety, N-methylpyrrolidinone is preferable. In addition, the mixture of xylene, toluene, and ethylglycol monoethyl ether also can be used in the present invention.

The metal foil to be used in the present invention is not specifically limited. The metal foil can be obtained by calendaring or electroplating. The copper foil with low roughness surface or without coarsening treatment is preferable to be used. Specific examples of the commercially available copper foil useful in the present invention include F1-WS, F0-WS (Furukawa Electric Co., Ltd.), BHY, NK120 (Japan Energy Corp.), SLP, USLP (Nippon Denkai, Ltd.), 3EC-III, 3EC-VLP, 3EC-M3S-VLP (Mitsui Mining & Smelting Co. Ltd.), C7025, B52 (Olin Co. Ltd.), VSBK, VSRD (Microhard Co. Ltd.).

The polyamic acid composition can be applied onto a metal foil by using a knife coater, a die coater, a gravure coater, or a wire coater. On the other hand, there is no particular restriction on the drying temperature, as long as the solvent used in the present invention can be vaporized without forming bubbles.

The flexible metal-clad laminate of the present invention is manufactured by applying a polyamic acid varnish onto a metal foil, drying the whole to form a partially cured and/or partially dried polyamic acid layer, and then being oven-dried it for a period of time, which may be accompanied by some curing, and subsequently heating and imidizing the resulting polyamic acid layer at 320 to 400° C. in an inert atmosphere (e.g., a nitrogen atmosphere) for at least 10 minutes to form a polyimide insulating layer on the metal foil. A flexible metal-clad laminate is obtained from this process.

The list of the abbreviations and their full names of the materials used in the following examples are shown as following.

### <Solvent, Dianhydride, Diamine>

### NMP: N-methylpyrrolidinone

BPDA: 3,3′,4,4′-biphenyl tetracarboxylic dianhydride
PDA: para-phenylene diamine
ODA: 4,4′-diaminophenyl ether

### <Rust-Inhibitors>

MIA: 2-methylimidazole
NSC: 3-(N-salicyloyl)amino-1,2,3-triazine
DAMIAT: 2,4-diamino-6-[2′-methylimidazoyl-(1′)]-ethyl-s-triazine
DAEMIAT: 2,4-diamino-6-[2′-ethyl-4′-methylimidazoyl-(1′)]-ethyl-s-triazine

### <Epoxy Resin>

YDCN704: cresol-novolak type epoxy resin manufactured by Tohto kasei Co. Ltd.
Epikote 1001: bisphenol A type epoxy resin manufactured by Shell Chemical Co. Ltd.
NC-7300L: naphthol-novolak type epoxy resin manufactured by Nippon Kayaku Co. Ltd.
The present invention shall be described in detail below.

### Examples 1 Through 9 and Comparative Examples 1 Through 4

0.553 kg (2.76 mol) of ODA and 0.999 kg (9.24 mol) of PDA are dissolved in 37.5 kg of N-methyl-2-pyrrolidone in a 60 L reaction vessel provided with a jacket for cooling or heating under a nitrogen gas ambient atmosphere, and the resulting solution is maintained at 50° C., and then 3.566 kg (12.12 mol) of BPDA is gradually added therein and a reaction allowed to occur for ten hours. Then, the polyamic acid solution with solid content 12 wt % is obtained.

In Example 1, DAMIAT (5% by weight with respect to 100% by weight of polyamic acid) and YDCN704 (5% by weight with respect to 100% by weight of polyamic acid) is added to the resulting polyamic acid solution and dissolved therein, and a polyamic acid varnish is obtained.

The polyamic acid varnishes pertaining to Examples 2 through 9 and Comparative Examples 1 through 4 are obtained by repeating the same procedure as in Example 1 except that the weight % of the imidazole or derivatives thereof (or the triazole or derivatives thereof) and the weight % of the epoxy resin, based on the weight of polyamic acid, are varied in accordance with the weight % shown in Table

TABLE 1

| | Imidazoles or Triazoles | | Epoxy resin | |
|---|---|---|---|---|
| | Compounds | weight % | Compounds | weight % |
| Example | | | | |
| 1 | DAMIAT | 5 | YDCN704 | 5 |
| 2 | DAMEIAT | 5 | YDCN704 | 5 |
| 3 | NSC | 5 | NC-7300L | 5 |
| 4 | DAMEIAT | 3 | YDCN704 | 5 |
| 5 | DAMEIAT | 7 | YDCN704 | 5 |
| 6 | DAMEIAT | 10 | YDCN704 | 5 |
| 7 | DAMIAT | 5 | EPIKOTE1001 | 5 |
| 8 | MIA | 5 | EPIKOTE1001 | 5 |
| 9 | DAMIAT | 5 | YDCN704 | 10 |
| Comparative | | | | |
| Example | | | | |
| 1 | NSC | 5 | — | 0 |
| 2 | MIA | 5 | — | 0 |
| 3 | DAMIAT | 5 | — | 0 |
| 4 | DAEMIAT | 5 | — | 0 |

Subsequently, the polyamic acid varnishes pertaining to Examples 1 through 9 and Comparative Examples 1 through 4 are applied onto the surface-roughened copper foils (F1-WS 18 μm electrolytic foils; Furukawa Circuit Foil) with a die coater until the thickness of polyamic acid reached 25 μm, and dried step by step in a progressive oven at 80 to 170° C. so that the polyamic acid layer is in a semi-dry state having a solvent content of 35%. The polyamic acid layer is heated in an atmosphere having an oxygen concentration of less than 10% by volume in an aging oven at 230 to 350° C., and imidized to form a polyimide insulating layer, and thus the flexible metal-clad laminate is obtained from this process.

### <Test Methods>

The adhesive strength (kN/m) between the polyimide insulating layer and the copper foil is determined according to JIS-6471 standard. The results are shown in Table 2 for Examples 1 to 9, and Table 3 for Comparative Examples 1 to 4.

The soldering resistance test is carried out according to JIS-6471 standard. The results are shown in Table 2 for Examples 1 to 9, and Table 3 for Comparative Examples 1 to 4.

The flatness (curling or not) of the obtained flexible copper-clad laminate is determined by cutting it into 100 mm×100 mm pieces and measuring the heights of four corners of each piece. The results are shown in Table 2 for Examples 1 to 9, and Table 3 for Comparative Examples 1 to 4.

TABLE 2

| | Imidation process | | | | | |
|---|---|---|---|---|---|---|
| | Existence | Contamination | Flexible copper-clad laminates | | | |
| | of the | of the | Contamination | | | |
| | vapor | imidation | of the glossy | | Adhesive | Soldering |
| | residue | process | surface of the | | strength | resistance |
| Example | substance | apparatus | copper foil | Flatness | (kN/m) | test |
| 1 | no | no | no | good | 1.25 | pass |
| 2 | no | no | no | good | 1.30 | pass |
| 3 | no | no | no | good | 1.40 | pass |
| 4 | no | no | no | good | 1.10 | pass |
| 5 | no | no | no | good | 1.30 | pass |
| 6 | no | no | no | good | 1.20 | pass |
| 7 | no | no | no | good | 1.25 | pass |
| 8 | no | no | no | good | 1.15 | pass |
| 9 | no | no | no | good | 1.25 | pass |

TABLE 3

| | Imidation process | | | | | |
|---|---|---|---|---|---|---|
| | Existence | Contamination | Flexible copper-clad laminates | | | |
| | of the | of the | Contamination | | | |
| | vapor | imidation | of the glossy | | Adhesive | Soldering |
| Comparative | residue | process | surface of the | | strength | resistance |
| Example | substance | apparatus | copper foil | Flatness | (kN/m) | test |
| 1 | yes | yes | yes | good | 1.35 | pass |
| 2 | yes | yes | yes | good | 1.10 | pass |
| 3 | yes | yes | yes | good | 1.30 | pass |
| 4 | yes | yes | yes | good | 1.25 | pass |

In Examples 1 to 9, the formation of vapor residue substance will not occur during imidation. The obtained flexible copper-clad laminate exhibits good flatness, and the glossy surface of the copper foil therein is not contaminated. Accordingly, the adhesive strength between the polyimide layer and the copper foil can reach to 1.25 kN/m, 1.30 kN/m, 1.40 kN/m, 1.10 kN/m, 1.30 kN/m, 1.20 kN/m, 1.25 kN/m, 1.15 kN/m, and 1.25 kN/m in Examples 1 to 9, respectively, and the obtained flexible copper-clad laminate can pass the soldering resistance test at 350° C. for 30 seconds. In Example 6, although the amount of DAEMIAT is more than the amount of Epoxy resin, the imidation process apparatus and the glossy surface of the copper foil can only be slightly contaminated during imidation.

Conversely, in Comparative Examples 1 to 4, the flexible metal-clad laminates, which contains polyimide insulating layers formed from polyamic acid varnishes which does not contain epoxy resin, do contaminate the imidation process apparatus and the glossy surface of the copper foil during imidation although the added imidazole or derivatives thereof (or the triazole or derivatives thereof) can improve the performance of the flexible copper-clad laminates in Comparative Examples 1 through 4.

In the present invention, the epoxy resin does not adversely affect the rust-inhibiting effect of the imidazole or derivatives thereof, or the triazole or derivatives thereof while the existence of it can prevent these rust-inhibitors from being vaporized.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. A polyamic acid composition, comprising: a polyamic acid obtained by addition polymerization of at least one aromatic diamine and at least one aromatic dianhydride in a solvent; at least one imidazole or derivatives thereof, or at least one triazole or derivatives thereof; and at least one epoxy resin.

2. The polyamic acid composition as claimed in claim 1, wherein the at least one epoxy resin is present in an amount of from 1 to 20% by weight with respect to the weight of polyamic acid.

3. The polyamic acid composition as claimed in claim 1, wherein the at least one epoxy resin is present in an amount of from 3 to 10% by weight with respect to the weight of polyamic acid.

4. The polyamic acid composition as claimed in claim 1, wherein the at least one imidazole or derivatives thereof, or the at least one triazole or derivatives thereof is present in an amount of from 1 to 10% by weight with respect to the weight of polyamic acid.

5. The polyamic acid composition as claimed in claim 1, wherein the at least one imidazole or derivatives thereof, or the at least one triazole or derivatives thereof is present in an amount of from 3 to 7% by weight with respect to the weight of polyamic acid.

6. A method for preparing a polyamic acid composition, comprising: adding at least one imidazole or derivatives thereof or at least one triazole or derivatives thereof, and at least one epoxy resin into a solution which contains a polyamic acid obtained by addition polymerization of at least one aromatic diamine and at least one aromatic dianhydride in the presence of a solvent, wherein the at least one epoxy resin is capable of reacting with the at least one imidazole or derivatives thereof, or the at least one triazole or derivatives thereof to form a polymer upon heating.

7. The method as claimed in claim 6, wherein the at least one epoxy resin is present in an amount of from 1 to 20% by weight with respect to the weight of polyamic acid.

8. The method as claimed in claim 6, wherein the at least one epoxy resin is present in an amount of from 3 to 10% by weight with respect to the weight of polyamic acid.

9. The method as claimed in claim 6, wherein the at least one imidazole or derivatives thereof, or the at least one triazole or derivatives thereof is present in an amount of from 1 to 10% by weight with respect to the weight of polyamic acid.

10. The method as claimed in claim 6, wherein the at least one imidazole or derivatives thereof, or the at least one triazole or derivatives thereof is present in an amount of from 3 to 7% by weight with respect to the weight of polyamic acid.

11. A method for preparing a polyimide, comprising:
(a) applying the polyamic acid composition as claimed in claim 1 onto a metal foil; and
(b) imidizing the polyamic acid composition to form a polyimide on the metal foil at a temperature in the range of 230 to 350° C., wherein the at least one epoxy resin reacts with the at least one imidazole or derivatives thereof, or the at least one triazole or derivatives thereof to form a polymer during the imidizing reaction.

12. The method as claimed in claim 11, wherein the imidizing reaction is carried out in an atmosphere having an oxygen concentration of less than 10% by volume.

13. A polyimide flexible metal-clad laminate, comprising:
a metal foil substrate, and
a polyimide insulation layer formed by imidizing the polyamic acid composition as claimed in claim 1 applied on the metal foil substrate.
